(19) United States
(12) Patent Application Publication
(10) Pub. No.: US 2016/0273090 A1
(43) Pub. Date: Sep. 22, 2016

(54) LOW PRESSURE GASEOUS HYDROGEN-CHARGE TECHNIQUE WITH REAL TIME CONTROL

(71) Applicant: ATOMIC ENERGY OF CANADA LIMITED, Chalk River (CA)

(72) Inventors: Zhang He, Deep River (CA); Jozef Francis Mouris, Deep River (CA)

(21) Appl. No.: 15/032,360

(22) PCT Filed: Oct. 28, 2014
(86) PCT No.: PCT/CA2014/051037

§ 371 Date: Apr. 27, 2016

Related U.S. Application Data
(60) Provisional application No. 61/896,337, filed on Oct. 28, 2013.

(51) Int. Cl. C23C 8/08; G01N 27/44; G01N 27/42; C22F 1/18

(52) U.S. Cl. CPC C23C 8/08; C22F 1/186; G01N 27/44; G01N 27/423

(57) ABSTRACT

A method for hydriding a material, such as a metallic or metal alloy, using coulometric titration. The method comprises placing the material to be hydrided inside a reaction furnace; introducing a flow of a gas mixture comprising hydrogen and optionally an inert gasto a first coulometric titration cell upstream of the furnace, through the reaction furnace, and into a second coulometric titration cell downstream of said furnace; heating the upstream and downstream coulometric titration cells; applying a current of oxygen ions to the gas mixture flow of the downstream coulometric titration cell under conditions effective to convert H₂ in the downstream coulometric titration cell to H₂O; and monitoring the current of oxygen, allowing the material to absorb a desired amount of H₂. The reduction in the current of oxygen can be monitored in real time to quantify the amount of hydrogen absorbed.

### FIELD OF INVENTION

Described herein are methods for hydriding a material, such as a metal or metal alloy, using coulometric titration.

### BACKGROUND OF THE INVENTION

Hydrogen embrittlement is a process by which various metals, including important structural alloys such as zirconium-, titanium- and iron-based alloys, form hydrides and become brittle as a result. Under mechanical stress, these hydrided metals may fracture, leading to potentially catastrophic accidents. Hydrogen embrittlement is often the result of unintentional introduction of hydrogen into susceptible metals during fabrication, but can also occur in structural components in service through absorption of hydrogen from the environment.

As a result, standardized mechanical tests are widely used in industry to determine the maximum stress that a material or component can withstand. In certain materials, these tests are performed on hydrided specimens that contain hydrogen in known amounts. Presently, two methods are predominantly used to pre-charge these specimens with the desired amount of hydrogen, including (i) electrochemical processes, and (ii) high pressure gas charging techniques.

In the electrochemical process, a weak acid solution is used as an electrolyte and the specimen is used as an electrode. A power supply is used for producing hydrogen in the solution, and by diffusion the generated hydrogen moves to the specimen to form a metal hydride layer on the surface. The specimen is then heated to diffuse hydrogen from the hydride layer into the body of the specimen. After thermal diffusion, any excess hydride layer on the surface of the specimen is removed to meet specimen testing requirements.

There are two main drawbacks to using the electrochemical technique. First, the specimen needs to be heated to allow diffusion of the hydride layer into the body of the specimen. To diffuse relatively high amounts of hydrogen in a reasonable time, the temperature may need to be raised so high that the properties of the samples change, rendering any results irrelevant to the objectives of the test. In addition, machining or grinding of the specimen is required to remove the excess hydride layer from the surface. This can be time consuming, and potentially damage the specimen. Moreover, the mechanical hydride removal approach is not a practical solution for thin wall specimens. The amount of hydrogen that can be added to a specimen by this technique is also limited by the annealing temperature.

The high pressure gas charging technique is achieved by heating a specimen in a sealed pressure vessel, at high pressure (about 7 MPa) in the presence of hydrogen. However, there are safety concerns associated with this approach, particularly with using flammable, high pressure hydrogen. In addition, there have been reports in the literature that uniform distribution of hydrides in the specimen can be difficult to achieve using these methods.

Accordingly, there remains a need for new hydrogen charging techniques capable of hydriding material specimens.

### SUMMARY OF THE INVENTION

An improved method for hydriding a material, such as metals and metallic alloys, is provided.

Accordingly, provided herein in one aspect, is a method for hydriding a material. The method comprises:
placing the material to be hydrided inside a reaction furnace;
introducing a flow of a gas mixture comprising hydrogen and optionally an inert gas to at least one first coulometric titration cell upstream of the furnace, through the reaction furnace, and into at least one second coulometric titration cell downstream of the furnace;
heating the at least one first and second coulometric titration cells;
applying a current of oxygen ions to the gas mixture flow of the at least one second coulometric titration cell under conditions effective to convert H₂ in the at least one second coulometric titration cell to H₂O; and
monitoring the current of oxygen in the at least one second coulometric titration cell while the material heats in the reaction furnace for a time effective to allow the material to absorb a desired amount of H₂ from the gas mixture;
wherein a reduction in the current of oxygen from baseline measurements in the at least one second coulometric titration cell represents the amount of hydrogen absorbed by the sample.

In certain non-limiting embodiments of the described method, the heated gas mixture may be allowed to flow under conditions and for a time effective to purge air from the reaction furnace before the current of oxygen ions is applied to the gas mixture flow of the at least one second coulometric titration cell.

In further embodiments, which are also non-limiting, the method may include calculation of the amount of hydrogen added to the material based on the reduction in the current of oxygen from baseline measurements.

In addition, embodiments of the material to be hydrided may include metals and metal alloys, such as but not limited to those comprising iron and steel, zirconium, magnesium, titanium, vanadium, manganese, nanomaterials and metal-based composite materials, or combinations thereof.

In further non-limiting embodiments, the gas mixture may comprise isotopes of hydrogen, such as deuterium and tritium. In addition, yet without wishing to be limiting in any way, the quantity of hydrogen in the gas mixture may range from approximately 2000 to 7500 ppm, although the quantity of hydrogen may vary widely depending on the application, amount of hydrogen to be charged in the material, and the stage in the hydriding method.

In addition, the at least one first and second coulometric titration cells may in certain embodiments be heated to temperatures, for example, in the range of about 700 to about 750° C.

In other non-limiting embodiments, the H₂ content in the gas mixture of the at least one second coulometric titration cell may be continually monitored, and the current continually adjusted to supply an amount of oxygen needed to convert all H₂ to H₂O. In addition, the at least one second coulometric titration cell may add a controlled amount of O₂ from the outside atmosphere to convert all H₂ not absorbed by the material to H₂O.

In addition, yet without wishing to limit the invention, in certain embodiments the operating pressure is maintained inside the reaction furnace at about atmospheric pressure, and argon is used as the inert gas.

The present invention also relates to an apparatus for hydriding a material by coulometric titration. The apparatus comprises:
a reaction furnace comprising a compartment adapted to receive a material to be hydrided;
at least one first coulometric titration cell, upstream of and in operable arrangement with the reaction furnace; and
at least one second coulometric titration cell, downstream of and in operable arrangement with the reaction furnace;
wherein the apparatus is configured to enable flow of a gas mixture comprising hydrogen and optionally an inert gas to said at least one first coulometric titration cell, through said reaction furnace, and into said at least one second coulometric titration cell, and wherein the apparatus further comprises means for heating the gas mixture in the at least one first and second coulometric titration cells to a temperature effective for hydriding said material.

In certain non-limiting embodiments, the apparatus may further comprise means for applying a current of oxygen ions to the gas mixture flow of the at least one second coulometric titration cell under conditions effective to convert H₂ in the at least one second coulometric titration cell to H₂O. The second coulometric titration cell may have the capability to transport the required amount of oxygen ions from the environment outside the system through the ceramic wall of the cell into the gas flow at the downstream end, and convert the retaining H₂ to H₂O. In such embodiments, the apparatus has the capability to determine the oxygen partial pressure inside the system, which is a function of the hydrogen concentration in the gas mixture after the gas passes the specimen.

In addition, the apparatus may also comprise in other non limiting embodiments a sensor for monitoring the current of oxygen in the at least one second coulometric titration cell while the material heats in the reaction furnace, and a processor for collecting the current data in real time and computing an amount of H₂ added to said material. The apparatus may also include at least one controller, for example to control the current of oxygen ions applied to the gas mixture flow of the at least one second coulometric titration cell, to control the temperature of the at least one first and second coulometric titration cells, to control the flow rate of the gas mixture, and/or to control the hydrogen content of the gas mixture.

In yet further non-limiting embodiments of the described apparatus, it is also envisioned that the compartment adapted to receive the material for hydrogen charging comprises a container, and wherein the reaction furnace further comprises an oxygen absorber to prevent surface oxidation of the sample during charging.

According to other embodiments and features of the described apparatus and method, the furnace temperature may be adjusted in the range of between about 250° C. and 1000° C. This feature enables user to experimentally determine the optimal heating temperature for hydriding a specific material. Also, this feature enables the user to experimentally determine the optimal condition for each hydriding process, i.e., the best combination of temperature, hydrogen concentration in the gas mixture and time.

In addition, yet without wishing to limit the invention, the temperature profile along the axial direction of the furnace can be adjusted. For example, a linear temperature gradient with a desired slope can be attained. This particular feature can be used by user to conduct a systematic study on the effect of temperature on the hydriding process of a specific material.

In further non-limiting methods, the apparatus can be used to determine the hydrogen absorption rate of a material. By altering the operating temperature, the absorption rate as a function of temperature can be determined.

The apparatus, in additional embodiments of the invention which are non-limiting, can be also used to determine the dehydriding rate of a material. As temperature increases, the hydrogen originally present in the material will escape from the material. By altering the operating temperature, the dehydring rate as a function of temperature can be determined.

### BRIEF DESCRIPTION OF THE DRAWINGS

These and other features of the invention will become more apparent from the following description in which reference is made to the following drawings:

FIG. 1 illustrates a schematic diagram of a coulometric titration apparatus, which can be employed in embodiments of the invention for gaseous hydrogen charging;

FIG. 2 illustrates a graph showing the titration current over time during gaseous hydrogen charging of a Zircaloy-4 specimen in Ar gas containing 4000 ppm H₂ at 400° C. The dotted line represents the temperature profile and the solid line is the fit of the experimental measured baseline;

FIG. 3 illustrates a cutting diagram of the Zircaloy-4 cladding tube (a) and sheet material (b) specimens for metallographic examination, DSC examination and HVEMS;

FIG. 4 illustrates a graph showing DSC data of the Zircaloy-4 sheet specimen with a nominal hydrogen content of 300 ppm;

FIG. 5 illustrates a graph showing hydrogen content CH versus TSSD temperature as measured by DSC. The triangles are the measured hydrogen content by HVEMS, and the circles are the hydrogen content calculated. The dashed line represents the fit to the experimental data;

FIG. 6 illustrates an optical micrograph of a uniformly hydrided Zircaloy-4 sheet specimen with nominal hydrogen content of 300 ppm. (a) low magnification and (b) high magnification;

FIG. 7 illustrates X-Ray spectra of a Zircaloy-4 sheet specimen hydrided to a nominal hydrogen content of 150 ppm.

### DETAILED DESCRIPTION

Unless defined otherwise in this specification, technical and scientific terms used herein have the same meaning as commonly understood by one of ordinary skill in the art and by reference to published texts, which provide one skilled in the art with a general guide to many of the terms used in the present application. It is to be noted that the term “a” or “an” refers to one or more. As such, the terms “a” (or “an”), “one or more,” and “at least one” are used interchangeably herein. The words “comprise”, “comprises”, and “comprising” are to be interpreted inclusively rather than exclusively. The words “consist”, “consisting”, and its variants, are to be interpreted exclusively, rather than inclusively. As used herein, the term “about” means a variability of 10% from the reference given, unless otherwise specified. It is to be noted that all ranges described herein are intended to include the respective endpoints in the range, e.g., from 1-10, includes both 1 and 10.

Described herein is a coulometric titration gaseous charging technique which can be used to add hydrogen to material specimens and components at low pressure and relatively low temperatures.

In embodiments of the described method, hydrogen charging can be carried out on a specimen at low pressure, without need for a pressure vessel. Specimens are instead placed inside a glass tube or similar receptacle, and exposed to a flow of a hydrogen/argon gas mixture. The use of an argon mixture maintains hydrogen below the flammability limit.

In further embodiments of the method, the amount of hydrogen added to a specimen can be accurately and precisely controlled, at any time during the process. The amount of hydrogen that diffuses into the specimen thus can be controlled and monitored in real time.

In addition, no hydride layer forms on the surface of specimens using the present hydrogen charging method, and in certain preferred embodiments, higher levels of hydrogen concentration can be achieved in the specimen as compared to existing methods. Moreover, no thermal diffusion or machining of the specimen is required after the hydriding process.

The coulometric titration method used for gaseous charging may also incorporate, in further non-limiting embodiments of the invention, a real time control feature that can precisely and accurately add desired amounts of hydrogen into a specimen.

The coulometric titration method described herein is applicable to various materials of a wide range of sizes. For example, the method may be applied using an apparatus designed for mechanical testing of specimens with sizes typically required by ASTM standards, or using an alternate configuration of the apparatus for charging hydrogen into very large specimens. In other non-limiting embodiments, the method can be applied in commercial applications including the ageing of test samples, as well as for hydrogen storage/retrieval, for charging of hydrogen fuel cells, or in the development of hydrogen-doped nuclear fuels to enhance safety.

Thus, for instance, the method can be applied to charge a desired amount of hydrogen into various engineering materials (for example, but not limited to Fe-, Zr-, or Mg-based alloys) or associated components for characterizing their hydrogen-induced embrittlement by fracture toughness measurements.

In another example, the method can be applied in the development of fuel cell and other hydride-type battery materials. Without wishing to be limiting in any way, embodiments of this approach may involve any of the following development activities: searching and selecting appropriate battery materials, conducting kinetic studies, and/or performing effectiveness tests.

It is also to be understood that hydrogen charging as described herein can include the charging of hydrogen isotopes, including but not limited to deuterium. For example, the method can be used to add deuterium to structural materials used in heavy water reactors.

According to one particular example of the described method, which is non-limiting, the method may be carried out at an operating temperature in the range of about 700 to 750° C. and at an operating pressure of about atmospheric pressure (e.g. 1 atmosphere). The amount of time needed to carry out the method will mainly depend on the size of the material being hydrogen-charged. In one example, a zirconium tube with 0.4 mm wall thickness may only need about 3 hours to carry out the method such that hydride distribution is uniform.

In addition, according to further non-limiting embodiments of the described method, the hydrogen/argon gas mixture may contain less than 1% hydrogen in order to maintain hydrogen content well below the flammability limit for hydrogen gas mixtures. This provides an extra safety margin when hydriding materials. However, this range can vary e.g. about 0.05% to 4%. In another embodiment, the hydrogen content is 0.5% to 1%.

### EXAMPLE

Coulometric titration (CT) was used to charge mechanical test specimens of Zircaloy-4 to high levels of hydrogen concentration (above the hydrogen solubility limit), with uniform distribution of the hydride phase and without altering the specimen's original microstructure. The Zircaloy-4 samples were exposed to ultrahigh purity argon gas, containing up to 7500 ppm hydrogen in a quartz-tube furnace at 400° C. At this temperature and hydrogen partial pressure, the sample hydrogen uptake was controlled by the exposure time to the gas.

### Coulometric Titration Technique:

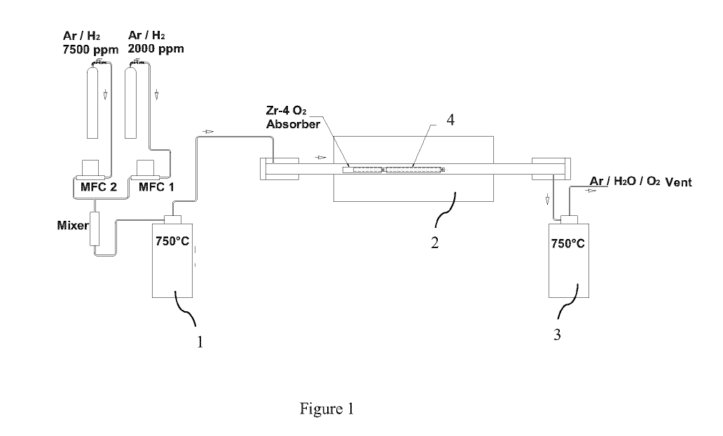

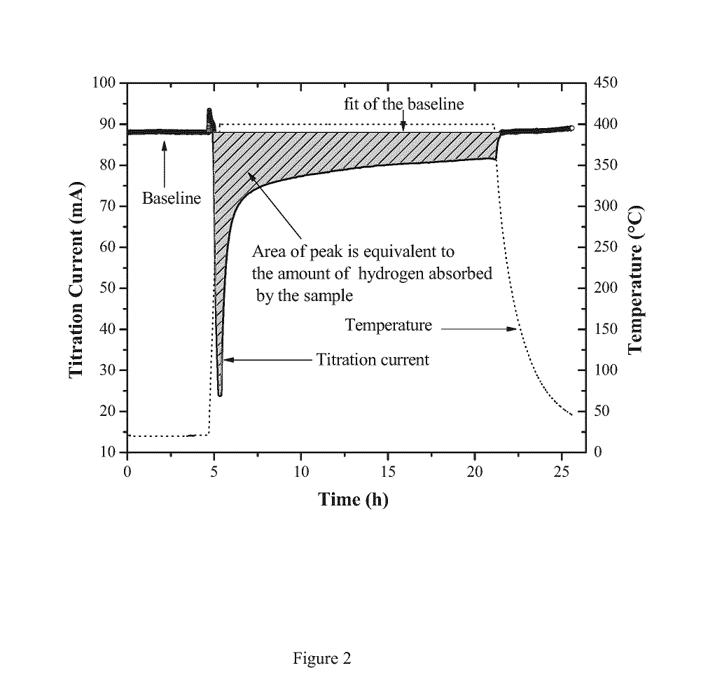

The basic operation of the CT equipment is shown schematically in FIG. 1. The CT equipment mainly consists of three components: an upstream CT cell (1), a reaction furnace (2), and a downstream CT cell (3). Initially, ultra high purity Ar gas containing a constant and known quantity of H₂ (varying from 2000 to 7500 ppm) flows through the upstream CT cell and passes over the sample (4) into the reaction furnace and then into the downstream CT cell (3). The upstream (1) and downstream (3) CT cells are heated at 750° C., but not the sample furnace. At room temperature no reaction between the sample and gas occurs. This initial step allows the purging of the sample space to a very low level of oxygen. It also allows the baseline to be established for the titration current peak (see FIG. 2).

In the downstream cell (3), just enough oxygen is added to convert all the H₂ to H₂O. The oxygen is added by passing a current of oxygen ions from the surrounding air through the ceramic cell wall at 750° C. into the gas. The composition of the gas in the downstream CT cell (3) is continually monitored, and a feedback loop continually adjusts the current in order to supply the precise amount of oxygen that is necessary to convert all H₂ to H₂O. For this reason, the current is termed the titration current. FIG. 2 shows the results of gaseous hydrogen charging of a Zircaloy-4 cladding tube specimen. The titration current in this figure represents the amount of oxygen ions needed in the downstream CT cell (3) to exactly convert all the H₂ to H₂O.

As the Zircaloy-4 sample heats up in the furnace (2), the sample absorbs hydrogen. Since a chemical equilibrium (2H₂+O₂=2H₂O) is maintained via the temperature of the furnace (2), the downstream cell adds a controlled amount of O₂ from the outside atmosphere to convert the remaining H₂ (not absorbed by the sample) to H₂O. Therefore, the amount of O₂ required in the downstream cell (3) to combine with the remaining H₂ is now decreased and shows as a drop of the titration current from the baseline (see FIG. 2). This difference in the amounts of O₂ (between the initial amount at room temperature and the decreased amount) is measured and integrated, which controls the hydrogen uptake in the sample as a function of the exposure time of the sample to the gas under a constant hydrogen partial pressure. The integrated value can then be calculated to obtain the total amount of hydrogen absorbed by the sample.

### Sample Preparation:

Samples were cut from cold rolled and stress relieved Zircaloy-4 cladding tube and sheet materials and were individually hydrided using the CT equipment described above. Plate specimens were 10 mm×20 mm×1.6 mm and tube specimens were 120 mm long. Prior to the hydriding charge, the surface of the specimen was cleaned to ensure uniform hydrogen charging. To remove the oxide layer, the specimen was polished with a series of abrasive papers up to 600 grit and then cleaned with wipes. The cleaned sample was weighed and immediately put into the quartz tube in the CT equipment furnace next to an oxygen absorber in order to avoid surface oxidation of the sample and promote hydrogen uptake during charging. After hydrogen charging at 400° C., the sample was furnace cooled to room temperature.

In order to obtain a uniform hydride distribution throughout the thickness of the samples, a homogenization heat treatment in argon gas atmosphere for 10 hours was applied. The H—Zr equilibrium diagram presents a eutectoide transformation at ˜550° C. To avoid both the phase transformation and the alteration of the original microstructure of samples, the homogenization temperature was lower than 550° C. and higher than the dissolution temperature. The samples were furnace cooled to room temperature. The slow cooling rate used is aimed at avoiding formation of y hydrides.

### Hydrogen Analysis:

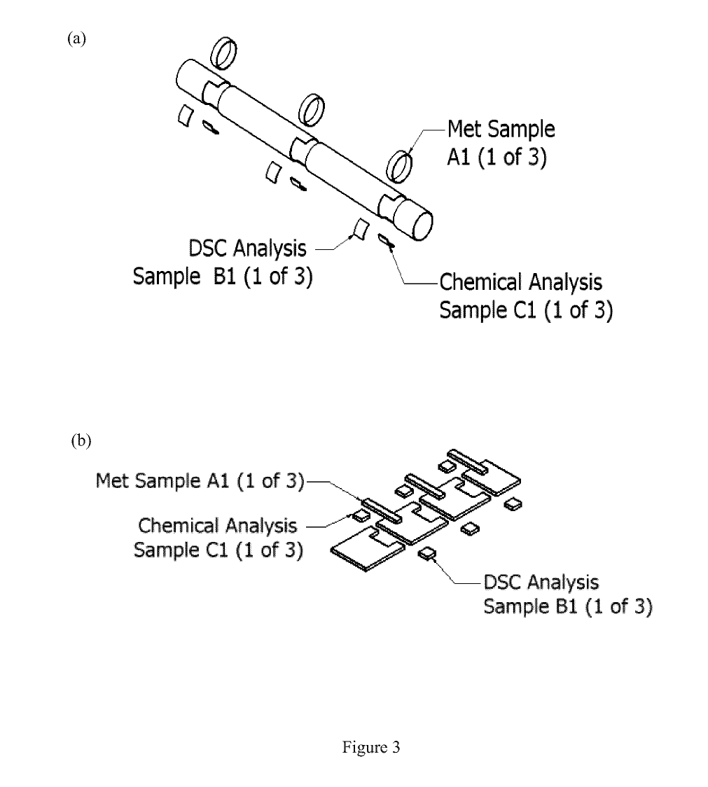

Hydrogen analysis consists of hydrogen uptake measurements and characterisation of the hydride distribution, orientation and morphology throughout the sample by metallographic analysis. The absorbed hydrogen content in the specimens was measured by a hot vacuum extraction mass spectrometry system (HVEMS). The hydride dissolution temperature of the specimens was evaluated with Differential Scanning calorimetry (DSC). The phase transition temperatures were measured for two runs. The runs consist of a cooldown to ambient temperature from some maximum temperature, followed by a heat-up to the same maximum temperature with a hold time of 5 min. The hydrogen-charged samples were optically examined for hydride distribution using standard metallographic procedures. The specimen for hydrogen analysis was cut into three sections from three different locations as shown in FIG. 3. The hydrogen concentration of each specimen was calculated as the mean of such measurements for at least three sections from the specimen in question.

X-ray diffraction measurements were also performed at room temperature using CuKa radiation to analyse the existing phases in the specimens using a scan step size of 0.010°.

### Experimental Results:

### Hydrogen Uptake Measurements:

The integrated area of the titration current peak shown in FIG. 2 is equivalent to the amount of absorbed hydrogen by the sample. In order to calibrate the integrated area for a given time exposure of the sample to gas under a known temperature and hydrogen partial pressure, the samples were analyzed for hydrogen concentration by HVEMS. Their hydrogen contents range from 15 to 390 ppm (by weight), and the statistical errors were within 2%.

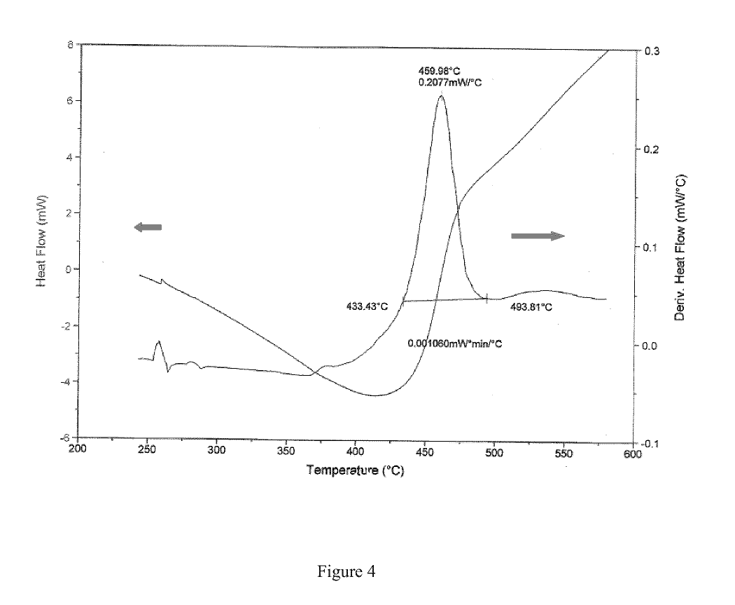

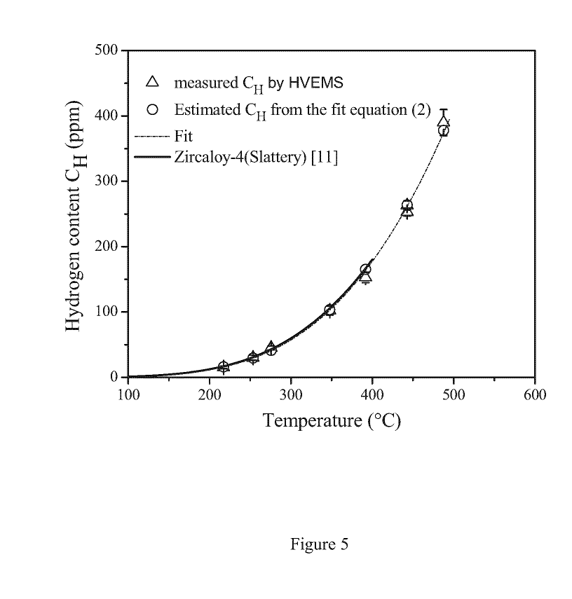

As shown in the cutting diagram in FIG. 3, the hydride dissolution temperature of the samples cut from plate and tube specimens was evaluated by DSC in the temperature range from 217 to 488° C. FIG. 4 shows a representative DSC curve. The temperature at the peak of the derivative heat flow curve, 460° C., is the hydride dissolution temperature of the sample. These temperatures are summarized in FIG. 5 as the terminal solid solubility dissolution (TSSD) of the hydrides for the analyzed specimens. FIG. 5 shows the measured hydrogen content C_{H} by HVEMS, including the uncertainties of the hydrogen measurements, and the corresponding TSSD evaluated by DSC.

The TSSD shows a linear relation of lnC_{H} versus 1/T and can be fitted using the Van't Hoff's equation:

C_{H}=A exp(−Q/RT) (1)

Where C_{H}, A, Q (J mol⁻¹), R (8.314 J K⁻¹ mol⁻¹) and T (K) are the hydrogen content, a constant related to the dissolution entropy, the dissolution enthalpy, the ideal gas constant and the absolute temperature, respectively. The fit parameters A and Q are given in the expression below:

C_{H}=115844 exp(−36264.8/RT) (2)

The results are in good agreement with the data reported by Slattery between 30° C. and 400° C. (G. F. Slattery, “The terminal solubility of hydrogen in zirconium alloys between 30° C. and 400° C”, Journal of the Institute of Metals, Vol. 95, 1967, pp. 43.) as shown in FIG. 5.

Based on the DSC results, the reported values of hydrogen concentration using expression (2) were the average of at least three measurements as shown in the cutting diagram of FIG. 3. The maximum scatter of several sections cut from the charged specimen was within ±5% of the average. The reproducibility of this hydrogen charging technique was within ±17% of the average of hydrogen content present in the sample.

### Hydride Characterization:

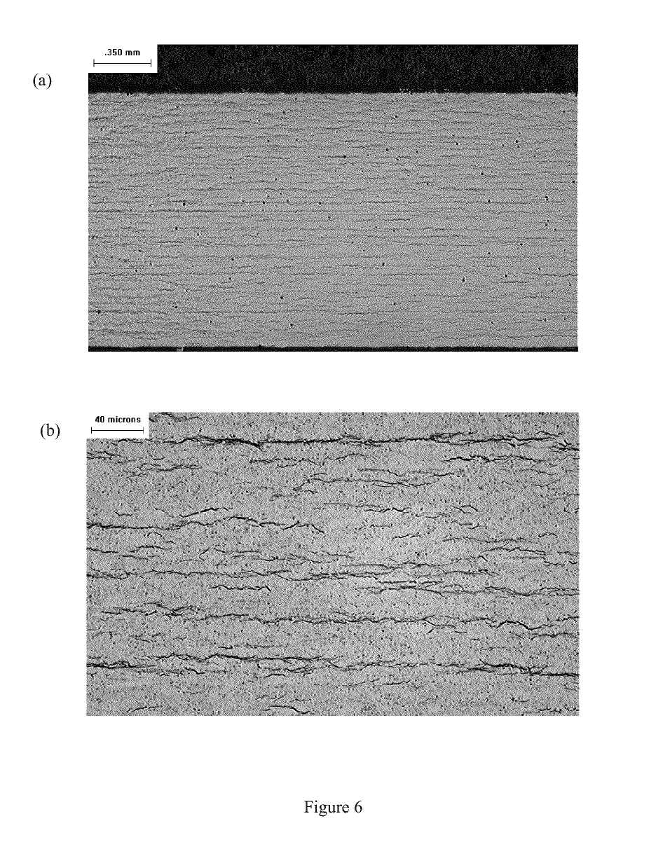

The charging uniformity was confirmed metallographically by examining the hydride distribution through the sample thickness from at least three different sections of the same sample. FIG. 6 shows typical optical micrographs of uniformly distributed hydrides in a Zircaloy-4 sheet specimen hydrided to 300 ppm. Hydride precipitates are platelet shaped, oriented in planes parallel to the rolling direction. The single peak in the heat flow response and its temperature derivative in FIG. 4 also indicates a uniform distribution of hydrides in the matrix, which is in good agreement with the optical examination results.

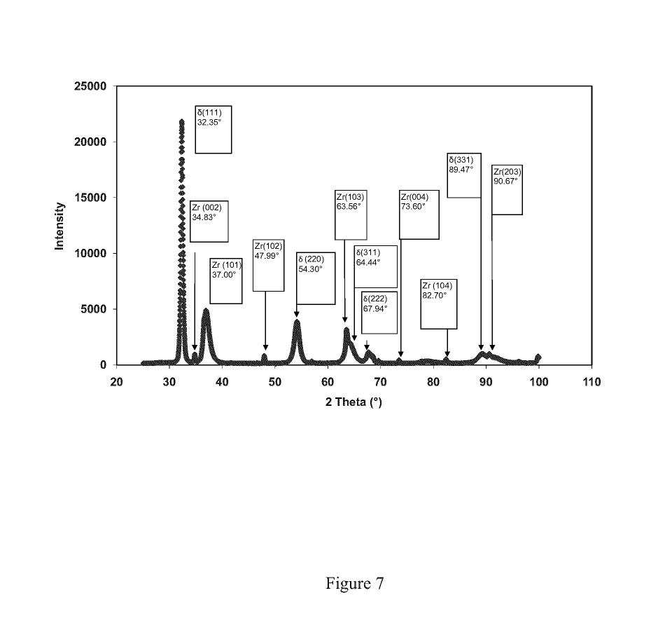

As was expected from the slow cooling rate used, only 6 precipitates were detected by X-ray diffraction. There was no evidence of precipitation of y hydrides as shown in FIG. 7.

One or more currently preferred embodiments have been described by way of example. It will be apparent to persons skilled in the art that a number of variations and modifications can be made without departing from the scope of the invention as defined in the claims. All publications cited in this specification are hereby incorporated by reference in their entirety.

What is claimed is:

1. A method for hydriding a material, comprising
placing the material to be hydrided inside a reaction furnace;
introducing a flow of a gas mixture comprising hydrogen and optionally an inert gas to at least one first coulometric titration cell upstream of said furnace, through said reaction furnace, and into at least one second coulometric titration cell downstream of said furnace;
heating the at least one first and second coulometric titration cells;
applying a current of oxygen ions to the gas mixture flow of the at least one second coulometric titration cell under conditions effective to convert H₂ in the at least one second coulometric titration cell to H₂O; and
monitoring the current of oxygen in the at least one second coulometric titration cell while the material heats in the reaction furnace for a time effective to allow the material to absorb a desired amount of H₂ from the gas mixture;
wherein a reduction in the current of oxygen from baseline measurements in the at least one second coulometric titration cell represents the amount of hydrogen absorbed by the sample.

2. The method of claim 1, wherein the heated gas mixture is allowed to flow under conditions and for a time effective to purge oxygen from said reaction furnace before the current of oxygen ions is applied to the gas mixture flow of the at least one second coulometric titration cell.

3. The method of claim 1, wherein the method further comprises calculating an amount of hydrogen added to the material based on said reduction in the current of oxygen from baseline measurements.

4. The method of claim 1, wherein the material is a metal, metallic alloy, intermetallic compound, in the form of either single crystal or polycrystal, metallic quasicrystals and nanomaterials, or a metal-based composite.

5. The method of claim 4, wherein the metal or metal alloy comprises iron, steel, zirconium, magnesium, titanium, vanadium, manganese, nickel, uranium, plutonium, thorium, nanomaterials, metal-based composite materials, or combinations thereof.

6. The method of claim 1, wherein the gas mixture comprises at least one isotope of hydrogen.

7. The method of claim 1, wherein the gas mixture comprises deuterium.

8. The method of claim 1, wherein the quantity of hydrogen in the gas mixture is 2000 to 7500 ppm.

9. The method of claim 1, wherein the at least one first and second coulometric titration cells are heated to a temperature of about 700 to about 750° C., inclusive of the endpoints.

10. The method of claim 1, wherein the H₂ content in the gas mixture of the at least one second coulometric titration cell is continually monitored, and the current is continually adjusted to supply an amount of oxygen needed to convert all H₂ to H₂O.

11. The method of claim 1, wherein the at least one second coulometric titration cell adds a controlled amount of O₂ from the outside atmosphere to convert all H₂ not absorbed by the material to H₂O.

12. The method of claim 1, wherein the operating pressure inside the reaction furnace is maintained at about atmospheric pressure.

13. The method of claim 1, wherein the inert gas is argon.

14. An apparatus for hydriding a material by coulometric titration, the apparatus comprising:
a reaction furnace comprising a compartment adapted to receive a material to be hydrided;
at least one first coulometric titration cell, upstream of and in operable arrangement with said reaction furnace; and
at least one second coulometric titration cell, downstream of and in operable arrangement with said reaction furnace;
wherein the apparatus is configured to enable flow of a gas mixture comprising hydrogen and optionally an inert gas to said at least one first coulometric titration cell, through said reaction furnace, and into said at least one second coulometric titration cell, and wherein the apparatus further comprises means for heating the gas mixture in the at least one first and second coulometric titration cells to a temperature effective for hydriding said material.

15. The apparatus of claim 14, further comprising means for applying a current of oxygen ions to the gas mixture flow of the at least one second coulometric titration cell under conditions effective to convert H₂ in the at least one second coulometric titration cell to H₂O.

16. The apparatus of claim 15, further comprising a sensor for monitoring the current of oxygen in the at least one second coulometric titration cell while the material heats in the reaction furnace, and a processor for collecting the current data in real time and computing an amount of H₂ added to said material.

17. The apparatus of claim 16, further comprising at least one controller to control the current of oxygen ions applied to the gas mixture flow of the at least one second coulometric titration cell, the temperature of the at least one first and second coulometric titration cells, the flow rate of the gas mixture, and/or the hydrogen content of the gas mixture.

18. The apparatus of claim 14, wherein the compartment adapted to receive the material to be hydrided comprises a quartz tube, and wherein the reaction furnace further comprises an oxygen absorber to prevent surface oxidation of the sample during charging.
